(19) United States
(12) Patent Application Publication
(10) Pub. No.: US 2011/0199635 A1
(43) Pub. Date: Aug. 18, 2011

(54) Printing Method Using Multiple Processors

(76) Inventors: I-Jong Lin, Half Moon Bay, CA (US); William Buzbee, Half Moon Bay, CA (US); Keith E. Moore, Palo Alto, CA (US)

(21) Appl. No.: 12/866,870

(22) PCT Filed: Feb. 8, 2008
(86) PCT No.: PCT/US2008/053503

§ 371 Date: Apr. 15, 2011

(51) Int. Cl. G06K 15/02

(52) U.S. Cl. 358/1.15

(57) ABSTRACT

A method of converting data for printing using a computer is disclosed herein. The computer comprises a first processor having first memory associated therewith and second processor having second memory associated therewith. The method includes converting at least a portion of a page in a printer defined language to a display list using the first processor; transferring the display list to the second memory; converting the display list to at least one bit map using the second processor; and transferring the bit map to the first memory.

### BACKGROUND

Printing involves converting data from a form viewable on a computer monitor or the like to a form that may be printed by a printer. For example, an image in the portable document format (PDF) may be represented by several images that are stacked on top of each other and may include a plurality of different colors. The image that should be printed is typically the image viewed from the top. In most circumstances, images underneath other images cannot be printed in two-dimensional printing. In order to covert an image for printing, a display list may be created, wherein the display list includes shapes to be printed. In addition, the display list may include the sizes, locations, and colors of the shapes.

The display list is then translated to a bit map or the like, wherein each dot to be printed is represented by a number or, in the case of color printing, a plurality of numbers. In some embodiments, bit maps are created for each colorant, such as ink in the printer. Thus, in a printer that uses six different colorants, six bit maps are created. In order to convert an image for printing, a display list may be created, wherein the display list includes shapes to be printed and/or high level constructs such as fonts and images. In addition, the display list may include the sizes, locations, orientations, and colors of the shapes and/or high level constructs.

As printers become faster, the need to speed up the data processing increases. At present, the creation of the bit maps slows the printing process.

### BRIEF DESCRIPTION OF THE DRAWINGS

FIG. 1 is a simplified diagram of an embodiment of a computer system having a central processing unit (CPU) and graphics processing unit (GPU) associated therewith.

FIG. 2 is a flow chart describing an embodiment of a printing process.

FIG. 3 is a chart showing an embodiment of a printing process using a GPU and a CPU simultaneously.

### DETAILED DESCRIPTION

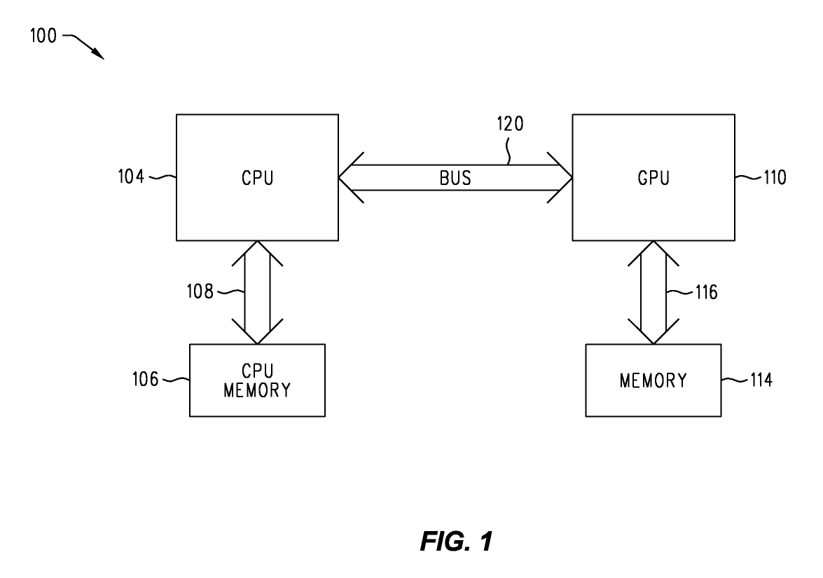

As described in greater detail below, methods of using two processors to convert data for printing purposes are disclosed herein. Some embodiments of the printing process are referred to as raster image printing. An example of a computer system 100 having two processors associated therewith is shown in FIG. 1. The computer system 100 has a central processing unit (CPU) 104, which is sometimes referred to as a first processor. The CPU 104 may be a general purpose processor as used in personal computers. The CPU 104 is associated with CPU memory 106 by way of a bus 108. The CPU memory 106 is sometimes referred to as first memory and is memory typically located in a personal computer. Likewise, the bus 108 is a bus that provides data transfer between the CPU 104 and the CPU memory 106.

The computer system 100 also includes a second processor 110, which is referred to herein as the graphics processing unit (GPU) 110. The GPU 110 may be a graphics accelerator as used in some computer systems. The GPU 110 may be manufactured to generate data representative of three-dimensional graphics for display. Accordingly, the GPU 110 performs repetitive processing on very large amounts of data. For example, the GPU 110 generates a number for every colorant of each dot that is to be printed on a page. If a page is printed using several colors, a number representing each color is generated for every no that is to be printed. Because the GPU 110 is adapted for graphics processing, it can process a great number of dots simultaneously, which significantly reduces the processing time. The GPU 110 is typically not a general purpose processor like the CPU 104.

A GPU memory 114 is associated with the GPU 110 by way of a bus 116. The GPU memory 114 is sometimes referred to as the second memory and may be used or accessed solely by the GPU 110. Because the GPU 110 processes such a large amount of data, the data transfer rate or memory throughput between the GPU 110 and the GPU memory 114 is fast. The increased data transfer rate is improved by the width of the bus 116, which may be three hundred to five hundred bits. The memory throughput of the GPU memory 114 may be greater than the memory throughput of the first memory 106. Both the GPU 110 and the second memory 114 may be located on the same circuit board, which may be connected to a personal computer interface (PCI) bus or the like within the computer system 100.

A bus 120 is used to transfer data between the CPU 104 and the GPU 110. The data transferred between the CPU 104 and the GPU 110 may be compressed. Therefore, the data transfer rate on the bus 120 may not need to be as great as the data transfer rate on the bus 116.

Having described the components of the computer system 100 relevant to printing, the use of the components will now be described in processing data for printing purposes.

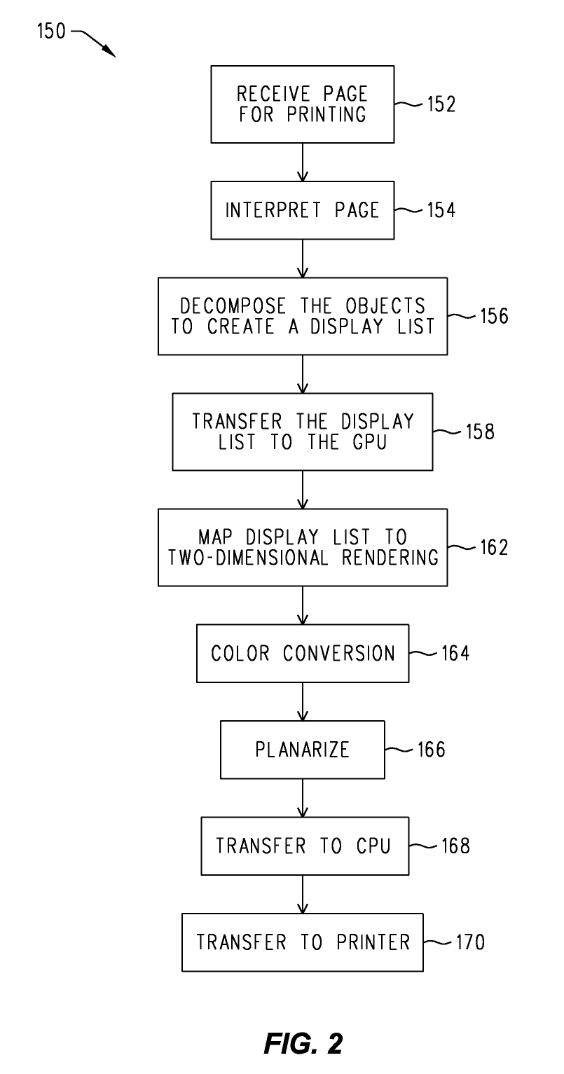

A flow chart 150 of the printing process is shown in FIG. 2. In step 152, a page or document is received for printing. The following description refers to the item to be printed as a page. The page may be in any of a plurality of different forms, such as a page description language. Such page description languages include portable document format, and XML paper specification (XPS). Receiving the page for printing may be accomplished by way of an instruction to the CPU 104 that initiates the printing in step 154, the page or page description language is interpreted. Interpretation may convert the page from the high level page description format to an intermediate data structure representation of the page. The output of the interpret step 154 is data that may contain objects, such as images, fonts, characters, and geometric shapes. The intermediate data structure of the page may be similar or identical to the high level page description format.

At step 156, the objects generated by the interpretation are decomposed into individual elements. At this stage, the date representative of the page is sometimes referred to as a display list. The display list may represent the page in three dimensions. For example, some images may be on top of one another. In one example, the page may be created by laying one image partiality on top of another, thus, the display list may contain both images, although only a portion of the lower image is to be displayed or printed. In other embodiments, the upper image may be transparent or have a degree of transparency. In these embodiments, portions of upper and lower images may be displayed and need to be decomposed, which is sometimes referred to as blending or combining.

With additional reference to FIG. 1, the display list is transferred to the GPU 110 for additional processing at step 158. More specifically, the display list may be transferred to the second memory 114 so that the GPU 110 may process it. In some embodiments, the display list may be compressed prior to transmitting it to the GPU 110. In step 162, the display list is mapped to a two-dimensional page for viewing or printing. This mapping is sometimes referred to as rasterizing. More specifically, the images on top of the page are processed so that they are viewed. This process is sometimes referred to as Z-ordering.

The data representation of the page may be in the form of a his map or other similar data structure, wherein numbers represent each dot to be printed. In the case of color images, a color conversion process, as shown at step 164, may need to be performed. The color conversion may generate several bit maps each representing a different color plane. For example, the original page may have been generated using red, green, and blue. The printer for which the page is to be sent may use cyan, yellow, black, and magenta to generate all colors. Therefore, a specific color generated by the red, green, and blue color planes needs to be represented by the cyan, yellow, black, and magenta color planes or bit maps. The GPU 110 may generate one color plane for each color that is printed by the printer. Each color plane may be a bit map wherein the bit map consists of a number corresponding to the color intensity for every dot to be printed. Thus, a high number may be indicative of a lot of colorant to be placed on a dot and a low number may be indicative of a little or no colorant, to be placed on a dot. The combination of colors printed will then print the aforementioned color.

The GPU 110 is well suited for the rasterization and color conversion. The GPU 110 may be a graphics accelerator that is designed to perform repetitive tasks on large amounts of data very quickly. Because the memory throughput associated with the GPU 110 is very large, it is able to process the bit maps quicker than the CPU 104. Therefore, having the GPU 110 perform these tasks improves the printing times of pages. In addition, the GPU 110 may only perform this single function. Accordingly, the data stored in the GPU memory 114 will not be changed by other processes, which enables the GPU 110 to process the data using high performance memory caching and access mechanisms that would be unsuitable for a general purpose CPU. Thus, after the GPU 114 sets a value of a memory location, the value will likely not have to change, which further increases the efficiency of the GPU 110.

The GPU 110 may then planarize the bit maps to place them in a form that is usable by the printer at step 166. The bit maps may then be transferred to the CPU 104 or the CPU memory 106 in step 168. In some embodiments, the bit maps are compressed prior to transferring by an conventional compression tool. In some embodiments, an Indigo Compression Format is used to compress the bit maps, in step 170 data is transmitted from the CPU 104 to a printer for printing.

The printing process has been described above as being performed on a page. In some embodiments, the process may be performed on a portion of a page, which reduces the amount of memory required for the processing. For example, several lines on a page may be processed as described above, followed by processing of successive lines of the page. In other embodiments, a page may be divided into portions, such as rectangular portions, and may be processed individually.

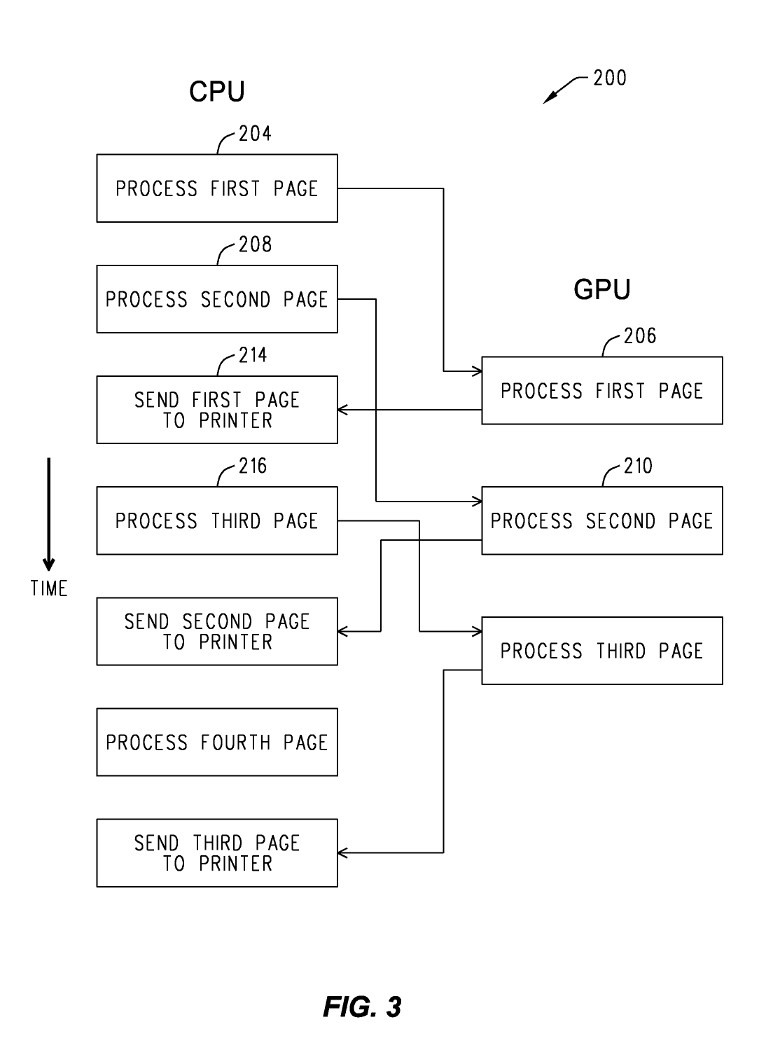

Because the processing described above is performed on two processors, they may work simultaneously on different portions of a page. An example of this processing is shown in the chart 200 of FIG. 3. The left column of chart 200 describes processes performed by the CPU 104 and the right side of chart 200 describes processes performed by the GPU 110. The time extends vertically downward as shown.

Printing commences at step 204 with the CPU 104 processing a first page or first portion of a page. The processing performed by the CPU 104 may include interpreting the page and decomposing the page to create a display list as described above and as shown by the flow chart 150 of FIG. 2. The display list of the first page is transferred to the GPU 110 for processing. Processing by the GPU 110 may include mapping the display list to create a two-dimensional rendering, color conversion, and planarization as described above and as shown in the flow chart 150 of FIG. 2.

While the GPU 110 is processing the first page, the CPU 104 processes a second page at step 208. When the GPU 110 is finished processing the first page at step 206, the GPU 110 transfers the data to the CPU 104 and the CPU 104 transfers the processed second page to the GPU 110. The GPU 110 and CPU 104 may now operate simultaneously. More specifically, while the GPU 110 processes the second page at step 210, the CPU 104 sends the data representative of the first page to the printer at step 214 and processes a third page at step 216. This simultaneous processing proceeds until all pages or portions of pages are printed. By using the GPU 110 and the CPU 104 simultaneously, the time required to print a page is significantly reduced.

What is claimed is:

1. A method of converting data for printing using a computer, said computer comprising a first processor having first memory associated therewith and a second processor having second memory associated therewith, said method comprising:
converting at least a portion of a page in a printer defined language to a display list using said first processor;
transferring said display list to said second memory;
converting said display list to at least one hit map using said second processor; and
transferring said at least one bit map to said first memory.

2. The method of claim 1 and further comprising converting said at least one bit map to a data format usable by a printer using said first processor.

3. The method of claim 1, wherein said first processor is a central processing unit.

4. The method of claim 1, wherein said second processor is a graphics processing unit.

5. The method of claim 1, wherein said second processor is a graphics accelerator.

6. The method of claim 1, wherein said display list comprises representations of shapes to be printed.

7. The method of claim 1, wherein said display list comprises representations of colors to be printed.

8. The method of claim 1, wherein said second processor performs color space conversion.

9. The method of claim 1, wherein said display list represents a three-dimensional image, and wherein said bit map represents a two-dimensional image.

10. The method of claim 1, and further comprising compressing said bit map prior to transmitting it to said first memory.

11. A method of converting data for printing using a computer, said computer comprising a central processing unit (CPU) having a first memory associated therewith and a graphics processing unit (GPU) having a second memory associated therewith, wherein the memory throughput of said second memory is greater than the memory throughput of said first memory; said method comprising:
converting at least a portion of a page in a printer defined language to a display list using said CPU;
transferring said display list to said second memory;
converting said display list to at least one bit map using said GPU; and
transferring said at least one bit map to said first memory.

12. The method of claim 11, wherein said GPU is a graphics accelerator.

13. The method of claim 11, wherein said display list comprises representations of shapes to be printed.

14. The method of claim 11, wherein said display list comprises representations of colors to be printed.

15. The method of claim 11, wherein said GPU performs color space conversion.

16. The method of claim 11 and further comprising converting said at least one bit map to a data format usable by a printer using said CPU.

17. The method of claim 11, wherein said display list represents a three-dimensional image, and wherein said bit map represents a two-dimensional image.

18. The method of claim 11, and further comprising compressing said bit map prior to transmitting it to said first memory.

19. A method of converting data for printing using a computer, said computer comprising a first microprocessor having first memory associated therewith and second microprocessor having second memory associated therewith, said method comprising:
converting at least a portion of a page in a printer defined language to a display list using said first microprocessor;
transferring said first display list to said second memory;
converting page description language representation of a second image to a second display list using said first microprocessor;
converting said first display list to at least one first bit map using said second processor;
transferring said at least one first bit map to said first memory; and
transferring said second display list to said second memory.

20. The method of claim 19 and further comprising converting said at least one first bit map to a data format usable by a printer using said first processor.

21. The method of claim 19, wherein said first processor is a central processing unit.

22. The method of claim 19, wherein said second processor is a graphics processing unit.

23. The method of claim 19, wherein said second processor is a graphics accelerator.

24. The method of claim 19, wherein said first display list comprises representations of shapes to be printed.

25. The method of claim 19, wherein, said first display list comprises representations of colors to be printed.

26. The method of claim 19, wherein said second processor performs color space conversion.

27. The method of claim 19, wherein said first display list represents a three-dimensional image, and wherein said first bit map represents a two-dimensional image.

28. The method of claim 19, and further comprising compressing said bit map prior to transmitting it to said first memory.
